(19) United States
(12) Patent Application Publication
(10) Pub. No.: US 2025/0131359 A1
(43) Pub. Date: Apr. 24, 2025

(54) AUGMENTING CHAT-BASED WORKFLOWS WITH LARGE LANGUAGE MODELS

(71) Applicant: Expensify, Inc., San Francisco, CA (US)

(72) Inventors: David M Barrett, San Francisco, CA (US); Daniel Vidal, San Francisco, CA (US); Tyler Karaszewski, San Francisco, CA (US)

(21) Appl. No.: 18/924,699

(22) Filed: Oct. 23, 2024

Related U.S. Application Data
(60) Provisional application No. 63/545,328, filed on Oct. 23, 2023.

(51) Int. Cl. G06Q 10/0633; G06F 40/35

(52) U.S. Cl. CPC G06Q 10/0633; G06F 40/35

(57) ABSTRACT

Examples provide for processing a natural language exchange to determine parameters for performing a task. Examples include processing the natural language exchange to identify one or more parameters of a requisite set of multiple parameters. A determination is made as to whether any parameters of the requisite set are omitted from the natural language exchange. If parameters are omitted, a set of natural language prompts is generated to prompt the user to supplement the exchange. The process is repeated using the supplemented natural language exchange. If no parameters are omitted, the task is performed using the requisite set of parameters.

### RELATED APPLICATIONS

This application claims benefit of priority to Provisional U.S. Patent Application No. 63/545,328, filed Oct. 23, 2023; the aforementioned priority application being hereby incorporated by reference in its entirety for all purposes.

### BACKGROUND

Chatbots and/or other chat-based solutions are increasingly used in user interfaces and/or interactions between humans and computer systems. However, chat-based solutions can have difficulty acquiring information needed to conduct a specific transaction or workflow, as this information is typically provided by a user in an unstructured manner.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 illustrates a network system for providing intelligent machine-generated or assisted information to users through a computer-implemented chat interface, according to one or more examples;

FIG. 2 illustrates an example interactive user interface for use with a chatbot, according to one or more examples;

FIG. 3 is a flow chart illustrating a method of implementing a chat service, according to one or more examples;

FIG. 4 is a flow chart describing a method of XXX, according to one or more examples; and

FIG. 5 is a block diagram illustrating a computing system for use with one or more examples, as described.

### DETAILED DESCRIPTION

Examples provide for a computer system for interacting with humans. In particular, a computer system is provided to enable autonomous chats with users, for purposes of collecting information for use in performing electronic transactions and/or other types of tasks for the users.

According to some examples, the computer system initiates a chat upon receiving a chat input from a user. The computer system can also record a state associated with the chat, such as with respect to a chat history associated with the chat input, previous chat histories for the user, and/or information related to a state of a user inquiry (e.g., request for assistance). The computer system can provide the chat input, chat state, and/or other data related to the chat and/or user as input into a large language model (LLM) and/or another type of machine learning model.

The computer also inputs, into the machine learning model, an instruction to the machine learning model to determine the intent of the chat (or user of the natural language exchange). For example, the instruction may correspond to a contextual prompt that asks the machine learning model to determine, based on the data related to the chat and/or user, whether the user intends to use the chat to perform a specific type of task. This task can include (but is not limited to) a travel booking, restaurant reservation, room reservation, meeting reservation, appointment, and/or another type of task involving an electronic transaction for which a workflow is available.

When the machine learning model responds to the input indicating that the intent of the chat is to perform a given task, the computer system uses the machine learning model to guide the interaction between the computer system and the user for the purpose of performing the task. More specifically, the computer system inputs at least a portion of a tree-based model for the electronic transaction workflow associated with the task into the machine learning model. The tree-based model includes a series of questions and decisions that can be used to collect information that is used to perform the task. The computer system also inputs a contextual prompt that instructs the machine learning model to use the tree-based model to generate natural languages messages to the user so that the requisite information can be acquired from the user.

The computer system transmits the natural language messages generated by the machine learning model to the user. The computer system also continues to interact with the machine learning model to (i) verify that chat inputs from the user continue to be related to the task and (2) generate additional messages for obtaining information used to perform the task from the user. The computer system additionally uses the machine learning model to determine if all information needed to perform the task has been obtained. When the machine learning model confirms that this information is complete, the computer system automatically performs the task by providing the information to and/or otherwise interacting with an application and/or service that can be used to perform the task. The computer system can also, or instead, provide the information to a human agent to allow the human agent to perform the task on behalf of the user.

In some examples, the computer system implements an active process (e.g., chatbot) to perform processes of maintaining the chat state and for selecting the resource to use for the chat response. The resources can include (but are not limited to) the machine learning model, humans, and/or programmatic resources (e.g., a chat data store or knowledge graph). When responding to chat input, the chatbot can provide information, identify information sources, and/or ask questions for the user to answer to progressively advance the interaction with the user.

In some examples, the chatbot can record information such as the chat input that generated the specific response, the chat state when the response was received, the resource used to generate a given chat response, and other information (e.g., contextual information). The information can be recorded (e.g., with a chat data store) for use in other chats.

The disclosed examples thus improve the efficient functioning of computers in carrying out chat-based electronic transaction workflows by leveraging the capabilities of an LLM and/or another type of machine learning model. More specifically, conventional chatbot systems typically operate using fixed workflows and/or databases of inputs and outputs and therefore are unable to handle unexpected chat inputs, deviations from conversational topics or tasks, and/or arbitrary amounts of unstructured information from users. In contrast, examples provide for a chat engine that efficiently determines that a user intends to use a chat to perform a certain task, carries out a structured interaction for obtaining information for performing the task, and determines whether or not the obtained information is complete. Consequently, examples provide for a chat engine or system that is capable of adapting electronic transaction workflows to a wide range of use cases, contexts, and/or communication styles from users.

As used herein, a computing device can refer to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network service.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, network equipment (e.g., routers), and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions.

Examples of non-transitory computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Augmenting Chat-Based Transactions with Large Language Models

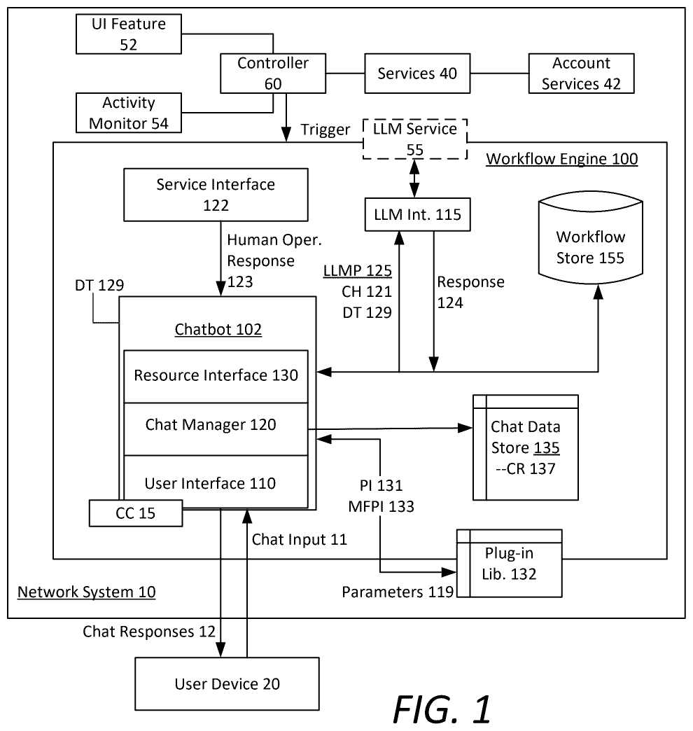

FIG. 1 illustrates a network system for performing tasks via a computer-implemented chat interface with users. By way of example, the network system 10 can be implemented as part of a website or network service, to enable various classes of consumers and/or enterprise users to receive rapid and context specific assistance to queries. Accordingly, in some examples, the network system 10 can be provided as a module running on a server that interacts with client computers who access the service from, for example, a website, or through a network enabled application or mobile device application (e.g., “app” downloaded from app store). Still further, some examples enable interaction with the network system 10 through a variety of communication mediums, as described in greater detail below.

While chats can be advanced with service operators who selectively receive and field chat queries, examples provide for the network system 10 to leverage the capabilities of LLMs and other resources for purpose of determining when sufficient information is provided for a given objective (e.g., performance of a task). In this way, the network system 10 can draw on additional resources to better refine the chat process, and in particular, to efficiently acquire sufficient information for a given objective from a natural language exchange where user input is highly unstructured.

As shown in FIG. 1, the network system 10 includes a set of services 40 (such as a user account service 42), a controller 60, and a workflow engine 100. The services 40 can include a portal or website where a task can be directed to—for example, the network system can include a booking engine as one of the services 40. As another example, the services 40 can include additional resources that augment or are otherwise relevant to task performance (e.g., receipt or financial transaction management, where tasks can be recorded and categorized/expensed, etc.). The workflow engine 100 implements processes for performing one or more types of tasks on behalf of users, using information obtained through natural language exchanges with the user. Accordingly, in examples, the natural language exchange is between user and programmatic entity (e.g., chatbot).

The workflow engine 100 can include a natural language interface (represented in FIG. 1 with chatbot 102), which utilizes large language model(s) (LLM(s)), to process and understand unstructured natural language input of a user. The workflow engine 100 uses information determined from the natural language exchange to perform a task for the user. The processes performed by the workflow engine 100 can optimize the communications generated/provided through the chatbot 102 for purpose of obtaining requisite information for performing a task. The optimizations can reduce, for example, the amount of time, the number of exchanges between chatbot 102 and user, the amount of natural language input that the user is required to provide (e.g., the number of words the user has to say in order to provide the required information) and/or the amount of computing resources that are used to obtain the requisite information and/or perform the task for the user, as compared to what would be required from a chatbot system that operates without such optimizations.

Further, as described with examples, the workflow engine 100 enhances the functionality and use of a network service that utilizes one or more LLM models (“LLM service”).

With reference to FIG. 1, the workflow engine 100 implements chatbot 102 to obtain information through unstructured language input and exchanges with a user (or other entity). The chatbot 102 includes one or more processes to receive, process and respond to natural language input of the user. Examples recognize that input provided from one user to the next can vary in choice of terms, phrases, sequence and information initially provided. For example, the chatbot 102 can receive as input, phrases such as “Book me a fare”, “I need to catch a flight” or “flight to Chicago” etc. As described with examples, the workflow engine 100 recognizes any of the phrases as an initial inquiry to purchase a flight for the user. The workflow engine 100 can make an initial determination as to whether the initial input pertains to a particular topic or task type. As described with examples, the workflow engine 100 can implement a process to guide the chatbot 102 in prompting the user to provide additional information for completing the task. However, as described with examples, the chatbot 102 can operate to prompt the user for requisite information only when it is needed. Further, the chatbot 102 can operate to prompt for information that is specific to the task (or type of task) that is to be performed. The resulting natural language exchange can result in the user being guided/prompted to efficiently provide requisite information for performing a particular type of task, with information being obtained with Fewer interactions and prompts that would otherwise be required through conventional chatbots and LLM services.

The chatbot 102 can be triggered to conduct a natural language exchange, where the chatbot 102 performs one of (i) prompting the user to provide input, and/or (ii) detecting natural language input from the user. In examples, the chatbot 102 can initiate chats (or individual sessions with users) in response to events generated by functionality such as a website feature or monitor.

In some examples, the controller 60 detects a trigger signaled through a user interface feature 52 (e.g., user interaction with a website) or activity monitor 54 (e.g., user interaction with a mobile device app, or with a chatbot on a website), and the trigger signal can be used to initiate the workflow engine 100 for a given user. The workflow engine 100 can be implemented to obtain a requisite set of information for performing a particular type of task. In some examples, the network system 10 also performs the task for the user, using information determined through the natural language exchange. By way of illustration, workflow engine 100 can be linked to a user via a communication channel between a server of the network system 10 and the user's computing device. The user can trigger workflow engine 100 by interacting with a website (e.g., user selects “help” feature on website) or with a computing device and mobile app (e.g., user provides voice input that is detected and translated into text by the mobile device). When triggered, the workflow engine 100 can provide functionality for conducting the chat (or natural language exchange) between the chatbot 102 and the user.

In some implementations, the workflow engine 100 can be provided as an integral part of the network system 10. In variations, the workflow engine 100 can be provided as a separate network service that can be used with services of the network system 10. In other examples, the workflow engine 100 can be an independent service that is available to users over a network. As an addition or variation, functionality described with the network system 10 and/or the workflow engine 100 can be distributed between network computers (e.g., servers) and/or between network computer and user device (e.g., desktop, mobile device, etc.). For example, in some examples, the chatbot 102 can be provided on a user mobile device, while other processes described with the workflow engine 100 reside on a server or network system and communicate with the chatbot 102 over one or more networks. Still further, in some variations, the chatbot 102 can be distributed, with aspects of the chatbot 102 (e.g., end user-interface) being provided on a user device. For example, the user interface 110 for the chatbot 102 can be graphically displayed on a user device to receive user text input, and/or programmatically implemented on a mobile device to receive verbal input from the user.

In an example of FIG. 1, workflow engine 100 includes the chatbot 102 and an LLM interface 115. The workflow engine 100 operates to generate the chatbot 102 for individual sessions with users who are linked to communicate with the workflow engine 100. The workflow engine 100 can generate multiple instances of the chatbot 102 to handle chat input queries from multiple users at one time. Each chatbot 102 can be implemented as a process, or combination of processes that is initiated by the workflow engine 100 in response to, for example, natural language input and/or a trigger input 9 (e.g., the user opening a mobile app or accessing a feature on an app or website). In some examples, the trigger input 9 can be implemented as a chat input 11, such as in the case when a user utters a question into a mobile device running in listening mode. Among other functionality described with various examples, the chatbot 102 can receive user input, and also generate natural language output (e.g., conversational words, terms, phrases or sentences). As described with examples, the natural language exchange progressively or iteratively obtains information for performing a task for the user, with optimization(s) to reduce a number or amount of interaction with the user.

In an example of FIG. 1, the chatbot 102 includes a chat user interface 110, a chat manager 120, and a resource interface 130. In some examples, one or more components of the chatbot 102 can be implemented at least partially using logic that is downloaded onto the end user device (e.g., webpage downloaded on user device). Thus, for example, the workflow engine 100 can initiate the chatbot 102 for the user by triggering a script on the user device, which then connects to server-side programmatic components of the chatbot 102. Further, while some examples illustrate the user interface 110 as being part of the chatbot 102, in some variations, the user interface 110 is separate from the chatbot 102. In such variations, the user interface 110 can be provided by a separate component or application. For example, the user interface 110 can correspond to a voice assistance feature or application running on a user device.

The workflow engine 100 can initiate multiple instances of chatbot 102 to accommodate multiple users or entities requesting access to the workflow engine 100 from different devices. The workflow engine 100 can initiate the chatbot 102 in response to events such as a web page download, application launch, or program feature selection (e.g., through application). In some variations, the workflow engine 100 can enable type specific communication connectors 15 to receive chat queries through messaging protocols, such as Short Message Service (SMS), Instant Messaging (IM), and/or email. In one implementation, some or all processes or components of the chatbot 102 are local on a user device 20 (e.g., computer on which browser is provided, mobile device with app, etc.) when the chatbot 102 is active for a user. In variations, some or all processes or components of the chatbot 102 are resident on a network service or terminal. Still further, variations provide that alternative forms of the chatbot 102 can be run for maintaining chats in alternative communication mediums or for other designations.

In examples, the workflow engine 100 is responsive to chat inputs 11. The user's initial submission of chat input 11 can coincide with initiation of a chat session. In examples, at an initial instance, the chat input 11 may be in the form of a user question, statement, phrase or words (e.g., “get me a flight”, etc.). The initial chat input 11 can be provided by a user through interaction with the chat user interface 110. The chat user interface 110 can be in the form of, for example, a text entry interface, provided on a website or application (e.g., running on a mobile device). The chat manager 120 can associate the chat input 11 with an identifier that is specific to a user and/or session. The chat manager 120 can store information about the chat in a chat data store 135. In an example of FIG. 1, the chat data store 135 represents memory (e.g., cache or other memory optimized for rapid response) and/or persistent storage (e.g., hard drive, solid state drive, etc.) which the chat manager 120 uses to maintain a record of a given chat (“conversation record 137”), and/or a collection of chats with a given entity. The conversation record 137 maintained by chat data store 135 can include a chat identifier, a chat history (including the most recent chat input 11 and chat responses 12), state information (e.g., a current state of the chat, and/or a state related to events preceding the current chat session). In some examples, the state information for a chat session can be indicative of a progression of the chat from the initial state to an ultimate resolution. The resolution can include identification of a task to be performed. Alternatively, the resolution can include performance of the task, or other predetermined milestone related to performance of the task.

In some examples, the state of the chat can reflect a binary determination (e.g., in progress, complete), trinary (e.g., in progress, complete, non-actionable). Still further, the state of the chat can include multiple states, such as states that indicate the progression of the chat. If, for example, the task type is identified to be a travel reservation, the state can reflect (i) which requisite parameters have been determined for enabling completion of the task (e.g., identify or book the travel reservation), and/or (ii) which requisite parameters have not yet been determined for enabling completion of the task.

Still further, in some examples, the chat manager 120 maintains no state information in connection with determination of requisite information. If the user is active and has provided a chat input, the entire chat history of the associated conversation or session, as may be maintained by the conversation record 137, is subjected to natural language processing and analysis at one time. In some examples, the chat history 121 (including the most recent chat input 11 and response 12) is communicated to the LLM interface 115. If requisite information is missing for performing the identified task type, the chatbot 102 prompts (with chat response 12) the user for the specific information. The subsequent chat input 11 is received, and the chat history is supplemented or augmented with the additional chat input 11, and optionally the chat response 12 of the chatbot 102.

In examples, the chat history 121 includes a natural language exchange between user and chatbot 102, including each chat input 11 and response 12 of a current session. In some variations, the current chat session can be tied to a prior chat session, such that the chat history 121 includes the chat inputs 11 and responses 12 of the prior session. Collectively, the chat history 121 includes exchanges that are related to a particular task that the user initiates at a current or prior session. Additionally, in variations, the chat history 121 includes information that provides context for the chat. The context can include information that is local and/or global. Local context is confined to a single conversation, while global context can include multiple conversations in prior sessions or transactions involving a particular user.

As between a user and the chatbot 102, the conversation record 137 can include a string, or series of strings, that correspond to the entirety of the conversation between the user and the chatbot 102. While the natural language exchange is ongoing, the recorded natural language exchanges can grow to reflect each chat input 11 and chat response 12. The recorded natural language exchange can correspond to, or otherwise form the basis of the chat history 121 communicated to the LLM interface 115.

In examples, the chat manager 120 implements processes to maintain the chat history 121 (or conversation record) during an active session, where the conversation record comprises each chat input 11 and chat response 12 for the active session. To illustrate, initially, the chat history 121 can reflect an initial chat input 11, corresponding to a phrase or sentence provided by the user at the start of the session. Later in the session, the chat history 121 can include the initial chat input 11, the subsequent chat response 12, and one or more subsequent chat inputs 11 and corresponding chat responses 12. The chat history 121 can thus increase with time, until the workflow engine 100 has sufficient information to perform a task for the user.

In some implementations, the chat history 121 includes the natural language exchanges prior to resolution of the user query. As an addition or variation, the chat history is session-specific. For example, the user may initiate a session to utilize a service, where the session corresponds to a duration where the user is online or actively engaged with the chatbot 102.

In addition to maintaining the conversation record 137, the chat manager 120 initiates or implements processes to (i) determine one or more categorical designations of the conversation record 137, including the type of task to be performed; (ii) obtain requisite information contained in the conversation record 137, where the requisite information pertains to a type of task; and (iii) determine, based on the categorical designation(s), the determined requisite information and the decision tree, what requisite information has yet to be provided in the conversation. In some examples, the chat manager 120 implements the processes through use of one or more LLM services, via the LLM interface 115.

In some variations, the chat manager 120 communicates (i) the chat history 121, and (ii) one or more decision trees 129 for processing the chat history 121, to the LLM interface 115. The chat history 121 and decision tree 129 can prompt the LLM service 55 (via the LLM interface 115) for responses 124 that include categorical designations and requisite information identified from the chat history 121. The chat manager 120 can receive, and optionally implement additional processing on the response(s) 124 of the LLM interface 115. Based on the response(s) 124 from the LLM interface 115, the chatbot 102 generates chat responses 12 for the user.

As an addition or variation, the chat manager 120 implements processes to determine whether a chat input 11 of the user pertains to an existing or prior chat. The determination can be based on contextual information, such as a time interval between a timestamp of a newly received chat input 11 and a timestamp of a prior chat (e.g., the timestamp of the last chat input or chat reply of the prior chat history). As an addition or variation, the determination can be based on a topic or subject of the chat input 111. Still further, the determination can be based on an explicit input of the user. For example, in response to receiving a chat input 11, the chat manager 120 may respond 12 to prompt the user for input that identifies whether the request pertains to an existing conversation record 137. By way of illustration, the chat manager 120 can generate a response of “Does the request pertain to a prior conversation?” If the user's response is in the affirmative, the chat manager 120 can perform a search of the chat data store 135 to determine a most recent chat of the user. The chat manager 120 can, for example, query the chat store 135 for a chat history (or conversation record) that is associated with (i) a user identifier, (ii) an unresolved state, (iii) a time interval preceding the timestamp of the chat input 11 (e.g., 1 hour preceding the current chat input 11), and/or (iv) a subject or task type if the chat input 11 (or current conversation, from which the topic or task type is determined).

As an addition or variation, the determination as to whether a chat input 11 pertains to a prior chat of the user can be made by the LLM service 55. In some examples, the decision tree 129 communicated to the LLM service 55 can also include logic for making one or more initial determinations, including whether the current chat relates to a prior chat and/or the topic or task type relevant to the chat input. The decision tree 129 can include conditional logic where the determinations made by the LLM service 55 include initial determinations as to whether the chat input 11 pertains to a prior chat and/or whether the chat input 11 pertains to a particular task type or objective.

Still further, in some examples, the chat manager 120 communicates the chat history 121 (e.g., each natural language exchange of current session, and conditionally exchange of prior session with unresolved outcome) associated with the user to the LLM service 55, in response to receiving a chat input 11. Thus, if the chat input 11 is determined to be a new conversation, the chat history 121 may be limited to the new chat input 11. On the other hand, if the chat input 11 is determined to pertain to an existing chat history, then the prior chat history, supplemented with the chat input 11, can be subjected to natural language processing via the LLM service 55. In some examples, the chat history 121 includes natural language exchanges of a current session and of a prior session (or sessions), and the LLM service 55 processes the combined chat history 121 to make determinations as to whether the chat input 11 is for a new chat or inquiry or for an existing chat or inquiry.

Still further, in some variations, the chat manager 120 can continuously maintain a chat history 121 for a user without any state information (e.g., prior chat session, resolved versus unresolved, etc.). In response to receiving chat input 11, the chat manager 120 supplements the chat history 121 accordingly, and then communicates the entire chat history 121 to the LLM service 55. The chat manager 120 can include decision tree logic 129 to make determinations as described with examples, including initial determinations that identifies whether the most recent chat input 11 is related by intent, purpose or topic, to prior natural language exchanges associated with the user.

### Decision Tree Logic

In examples, the chat manager 120 processes the chat history by generating a series of questions (or information gathering prompts) for the LLM service 55 to determine, given the current conversation record 137, (i) one or more categorical determinations for the conversation record, (ii) requisite information provided in the conversation record given the categorical determination(s), and (iii) requisite information needed to perform the type of task. The series of questions can be structured in accordance with pre-determined logic, represented by decision tree 129. The decision tree 129 can include conditional logic (e.g., “if-then logic”) and/or decision nodes, where each decision node identifies an outcome of a question or query that is embedded with the decision tree 129. Alternatively, the decision tree 129 can be implemented by the chat manager 120 to obtain requisite information from the LLM service 55 using the current conversation record between the user and the chatbot 102.

In examples, the chat manager 120 communicates a function that defines the decision tree 129 to the LLM service 55. The function can be communicated along with the chat history 121 (e.g., including current and prior exchanges). Still further, in examples, the decision tree 129 specifies a series of questions for the LLM service 55 relating to what information the chat history contains. In some implementations, at least some of the questions included in the decision tree function 129 are conditional. The LLM service 55 can respond to a conditional question if a condition specified by the decision tree for that question is met. The condition specified for a conditional question can correspond to a response or determination of the LLM service 55 to a prior question of the decision tree. For example, the decision tree 129 can specify a series of questions of which at least some are conditional:
Is this conversation related to booking air travel?
   Response [“Yes”, “No”, “Unknown”]
   If “Yes”, is the conversation related to round-trip or one-way?
      Response (“round-trip”, “one-way” or “unknown”)
   If “round trip”, does the conversation specify a departure date and a return date?
   If “one way”, does the conversation specify a departure date?

In some examples, the decision tree 129 is provided to the LLM service 55 at one time, with the chat history 121. In variations, the chat manager 120 communicates the decision tree 129 is in parts. For example, the chat manager 120 can communicate a first decision tree 129 with the chat history 121 at a first time to the LLM service 55. Based on the response from the LLM service 55, the chat manager 120 can select and communicate a second decision tree 129.

In variations, the decision tree 129 can be selected or otherwise configured in accordance with the categorical designations and/or requisite information as it is determined. In such variations, the chat manager 120 selects the decision tree 129 from a collection of decision trees, based on, for example, a categorical designation of an initial chat input 11. The determination of which decision tree 129 to use can be based on, for example, alternative processing of the chat input 11, or an initial response from the LLM service 55.

In some variations, the chatbot 102 includes functionality to trigger additional processes to provide one or more chat responses 12 as a response to individual chat inputs 11. For example, the chatbot 102 can trigger one or more plug-ins 131 of the workflow engine 100 to perform processes that are specific to a user and/or chat history 121. The plug-ins include functionality that can be integrated or triggered by the chat manager 120 based on a set of parameters 119. The parameters 119 may be parsed, or inferred from the chat input 11, based on responses 124 of the LLM service 55 and/or processes of the chat manager 120. In some examples, the chat manager 120 selects individual plug-ins 131 to use from the plug-in library 132 for a given chat session based on one or more of the determined parameters 119.

The chatbot 102 can handle each chat input 11 by providing a corresponding chat response 12, where the chat response 12 includes at least one of (1) a question or prompt for the user to answer, and/or (2) information determined in response to the chat input 11 and/or previous chat responses 12. The chat manager 120 can update the chat history 121 of the conversation record 137 in the chat data store 135, in response to events occurring within a current chat session. Specifically, the chat manager 120 can update the conversation record 137 to record events that occur in the course of the exchange with the user. The events can correspond to, for example, the most recent chat response 12 and chat input 11.

Additionally, in variations, the chat manager 120 can maintain the chat history 121 with the conversation record 137, including the state of the chat (if applicable), as well as a state of a user-session or query during which the chat takes place (e.g., incomplete versus complete).

In some examples, the chatbot 102 uses the LLM service 55 to interact with one or more LLMs (or other types of machine learning models). More specifically, the chatbot 102 uses chat input 11 and/or contextual information from the chat data store 135 to generate a programmatic communication, shown as LLM prompt 125, for an LLM coupled to or in communication with the LLM interface 115. For example, the chat manager 120 can generate the LLM prompt 125 to the LLM service 55 using the chat history 121 and the decision tree 129. Depending on implementation, the LLM(s) can be locally maintained and updated. In such implementations, the LLM interface 115 and LLM service 55 can be implemented by processes or components that are internal or local to the network system 10 and/or workflow engine 100. In variations, the LLM interface 115 accesses one or more LLM services 55 over one or more networks, such as the Internet. Thus, in some examples, the LLM service 55 can be implemented by a third-party, separate from network system 10.

In some variations, the prompt 125 includes information related to the current state of the user (e.g., a current location, activity, scheduled event, etc. for the user), and/or general information related to the user (e.g., a profile for the user, preferences of the user, tasks previously performed by the user using workflow engine 100, etc.).

The prompt 125 can also include an instruction to determine the intent of the chat, given the chat input 11, chat response 12, and/or the contextual information. For example, the instruction may provide a list of one or more tasks that can be performed using one or more electronic transaction workflows in a workflow store 155. The tasks can include a travel booking, restaurant reservation, room reservation, meeting reservation, appointment, and/or other types of task that involve electronic transactions or communications. The prompt 125 can also ask the LLM interface 115 to determine, based on the data related to the chat and/or user, whether the user intends to use the chat session to have a task, as identified by the task list, performed using information the user identifies through natural language exchange(s) with the chatbot 102.

As described with other examples, the prompt 125 can also ask the LLM service 55, via the LLM interface 115, whether the chat history 121 pertains to a particular topic or task type, whether the chat history 121 pertains to a prior chat exchange or whether it is a new inquiry from the user, and/or whether the chat history 121 identifies all of the requisite information for performing the task type. Further, as described with examples, the LLM prompt 125 can include decision tree 129, for specifying logic or conditional questions from which the LLM service 55 can be used to determine information, such as which requisite information for the task has been specified, and whether any additional requisite information is still needed.

After the LLM prompt 125 is processed by the LLM service 55, chatbot 102 can receive the LLM response 124 from the LLM service 55. The LLM response 124 can be received via, for example, the LLM interface 115. For example, in some implementations, the LLM response can be 124 communicated by a third-party over the Internet. The LLM response 124 can identify a task that the user likely intends to use the chat to perform. The response 124 can alternatively indicate that the intent of the user cannot be determined, or that the user likely intends to use the chatbot 102 for another purpose that does not involve a task associated with the workflow engine 100.

The LLM response 124 can also identify requisite information for performing the task, whether any requisite information is still needed for performing the task, and if so, which requisite information is still needed.

When the LLM response 124 indicates that the intent of the user is to perform a given task associated with an electronic transaction workflow in workflow store 155, the chatbot 102 uses the LLM response 124 to guide the chat 101 for the purpose of obtaining information for performing the task. More specifically, the chat manager 120 selects a decision tree 129 which includes a series of questions and decisions that can be used to collect information that is used to perform the task. For example, the tree-based decision model 129 may include a decision tree that organizes questions, decisions, and/or other information that can be used by the chatbot 102 into one or more “flows” for obtaining requisite information for performing a particular type of task. In the case of an airline reservation, for example, the requisite information can identify, for example, a determination as to whether the flight is one way or round trip, a departure location, an arrival location, travel dates, travel times, booking type (e.g., transportation, rental car, hotel, etc.), a number of stops, fare class (e.g., first class, coach, etc.), and amenities. More generally, a travel reservation can also specify a travel mode (e.g., air, train, boat, car, etc.), and/or other information that can be used to make a travel booking.

The chatbot 102 can generate a new LLM prompt 125 that includes at least a portion of the selected decision tree 129 or tree-based model. The chatbot 102 also adds, to the new LLM prompt 125, an instruction to use a tree-based model to generate one or more chat responses 12. The content of the chat responses 12 can include user-prompts (e.g., questions posed to the user) for obtain additional information, such as requisite information from the user. For example, the instruction may request an opening line that can be used by the chatbot 102 to begin asking the user for information related to a travel booking. The instruction may also, or instead, request a sequence of questions and/or other types of chat responses 12 that should be asked by the chatbot 102 to obtain information related to the travel booking. The instruction may also, or instead, specify a specific data format for specifying the chat responses 12 (e.g., a keyword for a specific type of information to be obtained followed by a chat response for requesting that type of information from the user).

The chatbot 102 transmits the new LLM prompt 125 over the LLM interface 115 to the LLM. In response to the LLM prompt 125, the LLM service 55 generates a corresponding response 124 and transmits the response 124 over the LLM interface 115 to chatbot 102. The chatbot 102 parses the response 124 and extracts or otherwise determines one or more suggested chat responses 12 from the response 124.

The chatbot 102 transmits one or more chat responses 12 received from the LLM to the user via the user interface 110 and also receives additional chat input 11 from the user. For example, the chatbot 102 can transmit one or more questions that ask the user for information related to a travel booking. After the question(s) are transmitted, the chatbot 102 can receive additional chat input 11 from the user.

During this interaction with the user, the chatbot 102 can generate additional prompts that ask the LLM service 55 to verify that chat input 11 from the user continues to be related to a particular task. The additional prompts can also, or instead, request the LLM service 55 for suggested chat responses 12 that can be used to redirect the chat back to the task when a given chat input 11 is determined to be unrelated to the task and/or information needed to perform the task. The additional prompts can also, or instead, ask the LLM service 55 to extract specific pieces of information related to the task from the chat input 11 and/or generate formatted mappings between the pieces of information (e.g., data elements representing various types of information needed to make travel booking) and the corresponding values in the chat input 11. The additional prompts can also, or instead, request that the LLM interface 115 to generate additional chat responses 12 that can be used to obtain other information related to the task from the user.

In examples, the chat manager 120 includes or initiates processes to determine whether requisite information for performing a task is received. The processes determine, from chat input of the user, (i) information that is provided for performing the task, and (ii) requisite information that is still required or may be provided for performing the task. In determining whether requisite information has been provided during a natural language exchange, the chat manager 120 can map extracted information to, for example, an information template or structure that defines requisite information types for performing a particular type. The chat manager 120 can utilize multiple information templates, such as for performing different types of task.

The chat manager 120 can also initiate additional processes (represented by resource manager 130) to obtain information for performing an identified task. The additional information can include, for example, profile information about the user (e.g., preferences of the user), information determined from an aggregation of chats with other users, and/or human resources (e.g., mechanical Turk). The information determined by the resource manager 130 can include non-requisite information, such as a user's preference for a particular source (e.g., airline where user has mileage plan).

In variations, the LLM prompt 125 and decision tree 129 can prompt the LLM service 55 for identification of requisite information for performing the identified task. As an addition or variation, the LLM prompt 125 and decision tree 129 can also prompt the LLM service 55 for a determination as to whether sufficient requisite information is provided through the chat history 121. Still further, the LLM prompt 125 and decision tree 129 can also prompt the LLM service 55 for identification of requisite information that is not yet identified, for purpose of performing the task. The chat manage 120 can record identified requisite information as parametric information (represented by parameters 119) with the conversation record 137.

Accordingly, in examples, the chat manager 120 triggers one or more prompts to the LLM service 55, for purpose of determining if all of the requisite information needed to perform the task has been obtained. When the LLM interface 115 generates a response 124 indicating that this information is complete, the chat manager 120 updates the set of parameters 119 associated with the chat history 121. Additional processes can access the parametric set 119 to perform one or more tasks on behalf of the user. For example, one or more plug-ins 131 can access the parametric set 119 to perform a particular task, using, for example, a third-party website, portal or interface. The plug-ins 131 can then perform additional operations and/or interface with external services to perform the task using the set of parameters 119.

The chat manager 120 can also, or instead, escalate the task to a servicer via service interface 122. For example, the chat manager 120 may transmit a message that includes the information over service interface 122 to allow to a human agent to perform the task on behalf of the user and generate a human response 123 to additional chat input 11 from the user. The chat manager 120 can interact with the plug-in 131 performing the task to obtain, for example, an output or response resulting from performance of the task.

### Multi-Modal Chat

In examples, the chatbot 102 can utilize different processes or modes to analyze and respond to chat inputs 111. As described with some examples, the chatbot 102 can implement a first mode (or set of modes) that utilizes an LLM service 55 to analyze the chat history 121, where the analysis can incorporate a decision tree 129 communicated by the workflow engine 100. As an addition or variation, the chatbot 102 can implement a second mode (or set of modes) that utilize alternative logic and resources to process the chat input 101. Still further, for one chat session or history, the chatbot 102 can implement a hybrid mode, such as one where some questions or answered by the second mode (e.g., does the user chat pertain to an existing chat history or inquiry or is it a new inquiry), while a remainder of the chat session is processed under the first mode.

Examples of alternative logic that can be implemented by the chatbot 102 include keyword and phrase analysis, using, for example, probabilistic graphs. As an addition or variation, the chat manager 120 can also perform textual pruning or normalization, as well as determining context for individual chat input 11. The chat manager 120 can store the determined information with the chat data store 135. The context can identify whether the question input is a new chat or a continuation of a prior chat, or a follow on to a prior chat. The chat manager 120 can perform operations such as text normalization, contextual search, etc. in order to determine a content (e.g., follow on question, content, link to source material) for the chat responses 12. Based on context and other information, the chatbot 102 can make an initial determination of whether a suitable response (e.g., information or follow on question) is determinable given information and resources available to the chatbot 102.

In implementing an alternative mode, the chatbot 102 can use the resource interface 130 to interface with additional resources for determining an intent, requirement, and/or response to a chat input 11 and/or chat history 121. Such additional resources can include (1) manual servicers (human operators), and (2) a question library. In such alternative modes, the chatbot 102 can check use resources such as a chat library (which can include other chat histories, chat histories of other users, and aggregations thereof). The chat library can index chat histories and enable programmatic searches by keyword, or by similarity of strings (e.g., multiword searches) to identify relevant responses. Still further, the resource interface 130 can selectively forward chat inputs 11 or histories to service operators (e.g., via service interface 122) for responses. For example, when no suitable or similar chat histories are identified, the chat manager 120 can use the resource interface 130 to prompt one or more service operators for a response. The service interface 122 enables selective human operator responses to chat input 11. The chat manager 120 can record the chat input 11, as well as the human operator response 123, in the chat data store 135 as part of the conversation record 137. The chat manager 120 can also update information about the ongoing chat by changing the state of the chat and/or recording the chat responses 12 communicated to the user.

According to some examples, when alternative logic is implemented for the chatbot 102, the chat manager 120 can process the chat input 11 to detect triggers for implementing additional processes for specific tasks or objectives. For example, the chat manager 120 can maintain a dictionary of phrases, words or other inputs which are associated with specific processes or outcomes.

When the chatbot 102 and/or LLM cannot discern the task associated with a given chat input 11, the chat manager 120 can trigger human intervention via service interface 122 to determine a complete or final chat response 12. Once the chatbot 102 receives the human response from service interface 122, the chat manager 120 can update the conversation record 137 for the chat 101, so that a chat state, the word pattern, the action and other parameters resulting from implementation of a particular plug-in are recorded. The information of the record can then be stored and made part of a search library for other chat input 11. In this way, the workflow engine 100 can operate to generate chatbot 102 for individual users or sessions which are progressively more intelligent. With chatbot 102, the chat manager 120 can continuously expand its interpretative ability for understanding chat input 11 for a population of users.

### Plugins

In one implementation, the workflow engine 100 can maintain or access a library of programs, modules, connectors, scripts or other logic (collectively termed “plug-in”) for performing particular tasks or sets of operations. The workflow engine 100 can access a plug-in library 132 to initiate a plug-in 131 for performing a specific process. Each plug-in 131 of the plug-in library 132 may include logic for implementing a separate workflow, or series of steps. In examples, the plug-ins 131 relate to performance of a task that aligns with the intent of the user. The resource manager 130 can match the intent and/or requisite parameters with a particular plug-in 131. The identified plug-in 131 can execute, using the parameter set 119, where the parameter set 119 represents the requisite information for performing a task enabled through the plug-in 131. More generally, a selected plug-in 131 can implement processes for (i) determining an outcome (e.g., a result), based on a process that is triggered by chat input 11, and/or (ii) for performing one or more operations for performing a task, using requisite information determined from the chat exchange.

Depending on implementation, the plug-in 131 may have varying levels of complexity. By way of example, some plug-ins 131 may be determinative, meaning the steps for achieving the respective outcome are predetermined, while other plug-ins 131 may be non-determinative, meaning some steps for achieving the outcome of the plug-in are conditional, or based on conditions generated by performance of a prior step or condition. The plug-ins 131 can be triggered at varying states (e.g., place in a conversation) of a given chat session. One or more plug-ins 131 can also be triggered based on a response 124 from the LLM service 55 and/or independent of any responses received over the LLM interface 115.

In some variations, the resource manager 130 can determine whether any plug-ins of the plug-in library 132 match criterion extracted from the chat input 11 (match word phrase and state) and/or a given response 124 from the LLM service 55. In variations, the workflow engine 100 can initiate a universal or multi-function plug-in 133 that includes a common set of code for use in performing any one of multiple possible functions. For example, the multi-function plug-in 133 may include one or more workflows from the workflow store 155, each of which provide a service or function that can be used by other workflows, plug-ins or programmatic components, where each workflow determines a specific type of account and/or identifier (e.g., account number or service with third-party service) that is being referenced by the chat input 11. To further the example, the resource manager 130 can implement the multi-function plug-in 133 by analyzing the chat input 11, event record, and/or response 124 to determine, for example, specific parameters 119 relevant to a given task and the task to be performed.

The workflow engine 100 can include and/or access plug-ins 131 for implementing various types of workflow tasks. In some examples, the workflow engine 100 provides functionality for interacting with third-party services and sites. The workflow engine 100 can make individual plug-ins 131 accessible to the chatbot 102 that is initiated for a given user, in order enable the third-party website or service interaction.

According some aspects, plug-ins 131 for enabling specific interactions to be performed with third-party services or websites can be published online. The plug-ins 131 can also be published by third parties, for use with a chatbot as implemented by examples such as described with FIG. 1.

As an additional variation, micro formatted scripts can be developed separately from plug-ins 131 that are used by the chatbot 102. For example, scripts can be detected in real-time by a given chatbot 102 (or a plug-in initiated by the chatbot 102) in connection with the chatbot 102 performing a particular task (e.g., interacting with a particular site). The chatbot 102 can perform a task by identifying the particular script for the site or service, or alternatively for the particular task, and then loading the script in order to perform the task using user specific information (e.g., such as private information, or information user specified for the task). In this matter, the scripts can be selectively integrated by the chatbot 102 into an operative plug-in with capabilities for performing tasks of a particular type, category (e.g., for a website) or class (e.g., online access of user accounts). The source of such scripts can vary, and serve different purposes and utilities with varying degrees of specificity. Still further, the workflow engine 100 can include processes, integrated with or independent of chatbot 102, to perform queries of third-party services in order to enable automation of subsequent tasks on behalf of users, using input determined from a natural language exchange with the user. The chatbot 102 can perform a task by identifying the particular script for the site or service, or alternatively for the particular task, and then loading the script in order to commerce just task, using user specific information (e.g., such as private information, or information user specified for the task). In this matter, the scripts can be selectively integrated by the chatbot 102 into an operative plug-in with universal capabilities for performing tasks of a particular type, category (e.g., for a website) or class (e.g., online access of user accounts). The source of such scripts can vary, and serve different purposes and utilities with varying degrees of specificity.

In order to enable the chatbot 102 to perform tasks on behalf of the user, the workflow engine 100 can include functionality, either with the chatbot 102 or with other components of workflow engine 100, for enabling an initiated chatbot 102 to access and utilize authentication information for accessing the service or site where the task is to be performed. For example, the resource manager 130 can include processes, represented by resource manager 130, to access a private record or database (e.g., represented by the account services 42) for credential information, payment information, user profile information or preferences and other information for performing tasks on behalf of the user. In other variations, the chatbot 102 can request necessary permission from the user, and the information can be stored in a corresponding record or database, subject to rules regulating use of the data (e.g., information being limited for use for a specific purpose or with a particular task, deletion of data after event or passage of time, etc.). Still further, in other variations, the workflow engine 100 can include processes that set a cookie or other programmatic process to retrieve the necessary information from the user's account or device, with the user's exquisite permission.

### Communication Mediums

In some examples, the user interface 110 can include or access one or more connectors 15 for enabling communications using text-based mediums, like SMS, email, Intercom, Slack, IRC, or other standard text chat interfaces which are typical for communications amongst humans over a network. In some variations, the user interface 110 can include programmatic voice interaction, where vocal human input can be recognized as chat input 11, and chat responses 12 can be output as voice synthesis. The interaction between user and chatbot 102 can be conducted through, for example, a telephone, microphone/speaker and/or through use of a mobile app.

Still further, in some variations, the chatbot 102 can be triggered to initiate a session with the user. For example, the chatbot 102 can call the user to ask a series of questions. The answers from the user can be converted to text and processed as described.

As an addition alternative, the user interface 110 of the chatbot 102 can augment the text and voice chat with graphical capabilities and functionality, such as opened dialogs, and/or displayed lists and content. The graphical capabilities and functionality can be based on the chat history 121 and other associated information. In some variations, the graphics which accompany a given chat can provide another interface for the user to provide input for the chatbot 102. By way of analogy, the user interface 110 can generate graphical content that simulates the use of, for example, the whiteboard in real-time, and the user can interact with the whiteboard. In such implementations, updates to the graphical content can reflect results of events which update the chat state. The user interface 110 can, for example, prompt the user to make a choice or enter input through the graphical content. The chatbot 102 can update the content of the user interface 110, and erase and redraw the content as needed or after a given chat response 12. In this way, the chatbot 102 can create a multi-media conversational experience (interspersed with graphics, video, interact elements, sound, etc.) that goes beyond what could be communicated as between humans, in terms of results achieved through actions or information communicated.

In some variations, the chatbot 102 can include a programmatic hardware interface to use equipment and hardware resources to detect user reaction (e.g., movement of limbs, eyes, facial muscles, fingers etc.) through image and/or presence detection (e.g., user movement). As an addition or variation, the chatbot 102 can include image processing resources to process visual feeds in order to perceive what the user is viewing. The chatbot 102 can thus generate programmatic responses to video input that is also being viewed by the user. The user can, for example, motion or otherwise select an object of interest from the video, and the action can be detected by the chatbot 102. In a variation, the chatbot 102 can guide the user action to change or alter the video feed. For example, the user may be instructed to perform specific tasks based on the content of the video feed.

In some variations, the chatbot 102 can include a programmatic hardware interface to interface with sensors that monitor or observe a disabled user. Through the sensor(s), the chatbot 102 can detect user motion focused on communication movements of a disabled person. For example, the chatbot 102 can detect slight movements, such as eye movements or finger motions.

According to some variations, the user interface 110 can include logic for preprocessing user input. In particular, the user interface 110 can include logic to preprocess user input in order to generate semantically equivalent queries and inputs from phrases that otherwise differ by syntax. Such preprocessing can be used to normalize input from users. Additionally, the user interface 110 can include logic to augment the input with additional information that is not explicitly provided by the user, but can be inferred from external sources or background information detected via the user interface 110.

In some variations, the user interface 110 implements preprocessing to normalize or conform the chat input 11. In some examples, the chatbot 102 can implement any one of numerous algorithms to detect and replace typos. Additionally, examples recognize that tendencies for specific typos can vary based on the medium of communication. For example, when the user is interacting on a mobile keyboard, “typos” resulting from accidental keystrokes are common. When some unrecognized word is found in the input, the logic of user interface 110 can be replaced through a variety of algorithms (such as Levenshtein distance) with the correct word. Additionally, the chatbot 102 can detect the medium of the input (e.g., as contextual input) and correct typos based on known typo habits of that medium (e.g., the layout of the keyboard affects the typos created). Such medium and typo correction can yield normalized chat input 11 better than human capabilities.

In other variations, the user interface 110 can include grammar normalization logic, which can specify rules, for example, to normalize variations of a statement so that the chat input 11 is communicated in accordance with a normalized grammar. For example, rather than learning how to answer “Where's the office” and “Where is the office” as two different questions with the same answer, the logic of the user interface 110 can replace “Where's” with “Where is” in the preprocessing stage, so that there is only one question for the chatbot 102 to answer. In some variations, the logic of the user interface 110 can implement sentence diagramming to parse out the underlying sentence structure, and then match rules based on the structure rather than the exact text itself.

The user interface 110 can also include logic for slang correction. Often times different users will use different words to describe the same concept. With knowledge of regional dialect or even just common slang, some words can be replaced with their more common alternatives. For example, “soda” is more common than “pop” for describing carbonated beverages overall, but the preference is strongly influenced by region.

In some variations, the chatbot 102 can be programmed to access external database resources. In accessing external database resources, the chatbot 102 may infer, or otherwise determine information that is specific to the user, in order to more competently or efficiently implement the actions which are required from the user intent. Examples recognize that there are external sources of knowledge about the user that could be queried in real-time to help provide context for the input. For example, a public calendar published by the user (or private calendar shared with the chatbot 102) might indicate what the user is doing, which could provide crucial context to chat input such as “Where am I supposed to be?”—questions that come up in a hurry when the user doesn't have time to provide a more detailed question. Similarly, a user might specify chat input of “Where is something good to eat?” and the chatbot 102 could use external databases and resources to analyze buying habits of food (and compare to nearby restaurants) and to provide an answer that a human operator could only achieve through extensive questioning.

The resources of the chatbot 102 can enable background analysis of, for example, context carried along with the communication that isn't explicitly generated by the user. For example, a microphone can pick up the sounds of the environment around the user, and this sound could be analyzed by resources available to the chatbot 102, in order to automatically (e.g., without user input) determine the context of a chat input query. Machine learning, implemented by the workflow engine 100, can operate to not just understand if the user is indoors in a quiet office environment or standing on a noisy subway terminal, but also to hear the voices of the people nearby. Through interaction with the machine-learning resource, the chatbot 102 can identify what language is being spoken to infer location, or even learn and map out the “audio fingerprint” of the background to determine location, likely activity, mode of transportation, weather, or other context accompanying the user when the chat input 11 is submitted. The context can be used to determine the chat response 12.

According to some examples, multiple types of preprocessing such as described above can work in concert. Also, given that preprocessing is often ambiguous—there are many possible ways to preprocess the same input—many attempts of preprocessing might be tried sequentially (or in parallel). These various preprocessed inputs could be “scored” a variety of ways, such as by seeing which are the most grammatically accurate, which correspond to the most common input seen from other users, etc.

### Configuration of Chat Response

In examples, the output generated by the chatbot 102 is based on an output of the LLM service 55 or LLM model(s). In some examples, the chatbot 102 can generate responses 12 that are configured for the user or the particular context. Thus, the chatbot 102 can take a response 124 from the LLM service 115 and can modify, alter, configure or otherwise generate the chat response 12 to be configured for the user or context. Still further, some variations provide for the user interface 110 to also include functionality for rendering or otherwise presenting responses from the chatbot 102 in a manner that is more humanlike. According to one aspect, the user interface 110 includes a language library of terms and phrases for various dialects, including slang or age-related conversational terms. The chatbot 102 and/or LLM can include intelligence to detect the type of library which is most relevant to the user. For example, the chatbot 102 can include logic to match terms and phrases of the chat input 11 with a particular language identifier, from which the language library can be selected. In another example, the chatbot 102 may generate an LLM prompt 125 that asks the LLM service 55 to determine the language that is most relevant to the user.

In variations, the chatbot 102 can access or determine contextual information about the user. As examples, the contextual information can include geographic information about the user or source of the chat input 11, as well as demographic information (e.g., age) of the user. The sources of the contextual information can include, for example, the Internet Protocol (IP) address of the user, as well as demographic or profile information about the user.

The chatbot 102 can also modify or otherwise configure the chat responses 12 provided through the user interface 110 to accommodate specific facets of the user. The user interface 110 can include plug-ins, or interfaces to third-party services for enabling such functionality. For example, the chatbot 102 can include a translation plug-in or service that converts a chat response 12 from one language to a native language of the user.

As an additional variation, the chatbot 102 can include logic to detect the personality trait of the user, such as based on the propensity of the type of words the user uses (e.g., energetic, somber, technical etc.). In implementation, the chatbot 102 can access the LLM and/or libraries of terms and phrases in order to configure the output. For example, for a user that uses energetic expressions, the chat response 12 can include “great question! Would you happen to know the version of QuickBooks?” For another user, the chat response 12 can simply state “please provide a version of QuickBooks.”

The chatbot 102 may also use slang correction or other speech normalization logic to conform the chatbot's output to a style or format that is not the default or standard, but one that is specific to information known or inferred about the user submitting the chat input 11. For example, in some variations, the chatbot 102 can generate messages (e.g., questions) for the user based on information known about the user, such as geographical region. To further the example, the chatbot 102 would know to ask users in California “What kind of coke do you want?” given that it is used generally there to refer to “soda”, while a user in Colorado asking for a “a coke” likely means “Coca-Cola”. With access to statistical data that no human could remember, the chatbot 102 could appear more “worldly” than any human.

The user interface 110 can also include logic to implement translation from a native language to a language the chatbot 102 already recognizes—or even into an internal language that is unique to the chatbot 102. For example, the chatbot 102 can communicate with an external translation engine in order to translate the chat input 11 and/or the chat response 12. With access to translation resources, the chatbot 102 could be more multilingual than humans.

The user interface 110 can also include, or otherwise utilize resources for determining the location of the user from characteristics of the network communication with the user. Location information can be determined explicitly from chats, such as via a GPS-enabled chat interface, or implicitly via IP-geolocation of the incoming communication stream. Such resources can enable the chatbot 102 to have real-time knowledge of the user's location, and this information can be used to generate the response for the user.

Still further, the workflow engine 100 can include processes, integrated with or independent of chatbot 102, to perform queries of third-party services in order to enable automation of subsequent tasks using chatbots 102 that are acting on behalf of users. For example, websites can publish scripts or capabilities which are enabled for chatbots 102 in connection with user accounts or other services. In this way, a user can request an action (e.g., “Please book me a flight”) and the chatbot 102 can implement processes to determine which of its known sources allow it to execute that operation.

### Interactive User Interface

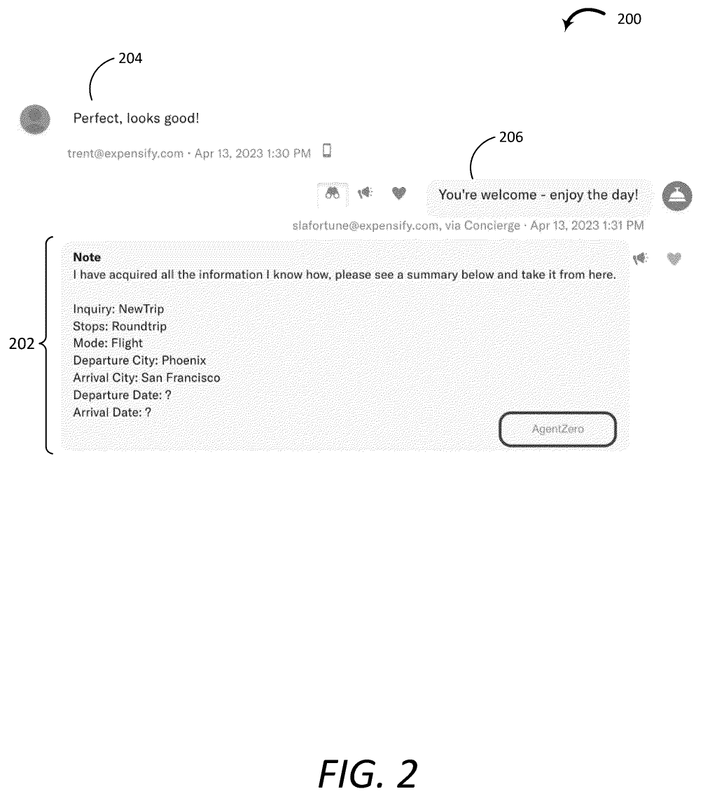

FIG. 2 illustrates an example interactive user interface 200 for use with a chatbot, according to one or more examples. As shown in FIG. 2, the example interactive user interface 200 shows a natural language exchange (or chat) between a user and the chatbot 102. The chat includes a chat input 204 from the user and a chat response 206 from the chatbot. Processes as described with FIG. 1 can be used to determine the intent of the user (e.g., perform a task or particular type of task, continue a prior chat or start a new chat, etc.), as well as requisite information for performing an identified task.

The chat also includes an example note 202 that can be generated by the chatbot 102. The note 202 includes a list of information acquired by the chatbot to facilitate a travel booking for the user. For example, the note 202 may include mappings between data elements (e.g., inquiry, round-trip or direct, stops, mode, departure city, arrival city, departure date, arrival date, etc.) used to make the travel booking and values of the data elements provided in previous chat input from the user. This information may be obtained over previous rounds of chat inputs and chat responses between the user and the chatbot. The chat responses may be generated based on additional interaction between the chatbot and an LLM service 55.

In an example shown, the note 202 is generated as a message for another entity, such as a human booking agent or assistance. As illustrated, the note 202 requests that a human agent complete the travel booking using the information provided. Thus, the note 202 may be transmitted over a service interface to the human agent for purpose of performing the task identified for the user intent. In variations, a plug-in or other programmatic component can use the identified information to automatically and/or programmatically perform the task.

### Methodology

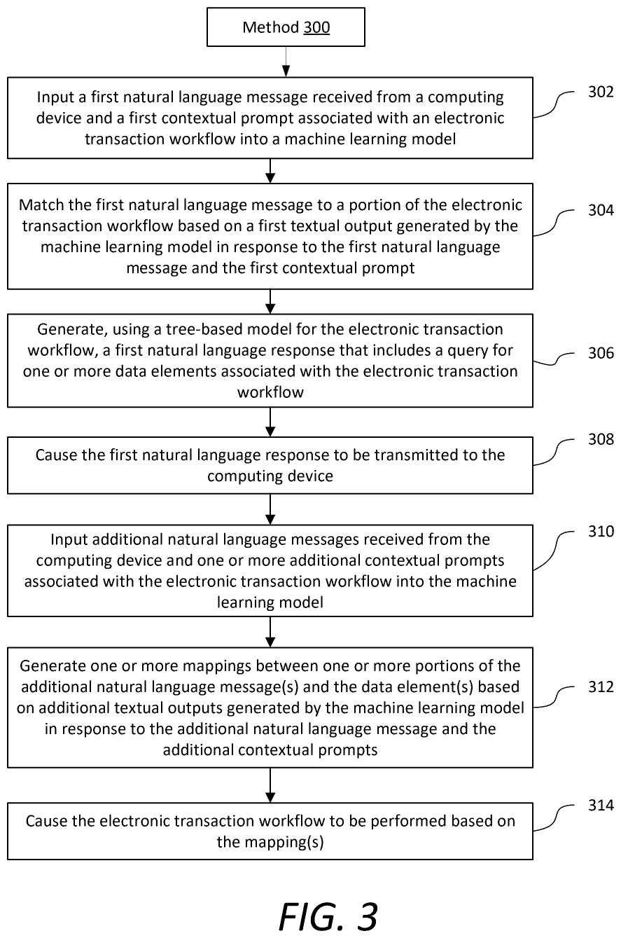

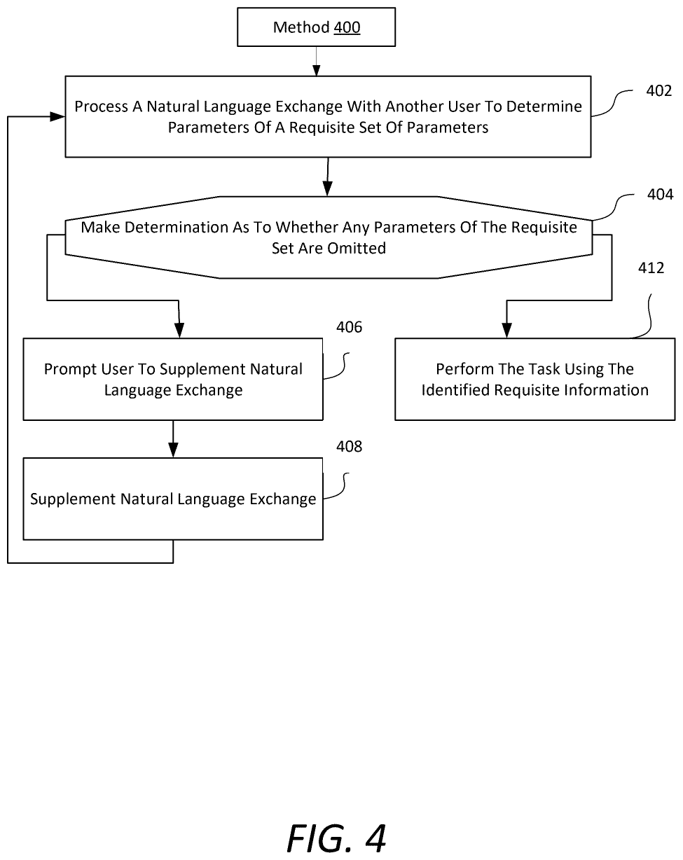

FIGS. 3 and 4 are flow charts describing methods related to the chatbot described with respect to FIGS. 1 and 2. In the below discussion of FIGS. 3 and 4, reference may be made to reference characters representing like features as shown and described with respect to FIGS. 1 through 3. Further, the steps represented by blocks in FIGS. 3 and 4 need not be performed in any particular sequence or manner, and certain steps may be performed in unison, prior to, or subsequent to any other step shown in the flow charts of FIGS. 3 and 4.

FIG. 3 is a flow chart illustrating a method 300 of implementing a chat service, according to one or more embodiments. At block 302, the network system 10 inputs a first natural language message received from a computing device and a first contextual prompt associated with an electronic transaction workflow into a machine learning model. For example, the network system 10 may receive the first natural language message as a chat input that is provided by a user of the computing device. The network system 10 may input a prompt that includes the chat input and an instruction corresponding to the first contextual prompt into an LLM corresponding to the machine learning model. The instruction may request that the LLM determine whether the chat input indicates an intent to perform one of a predefined set of tasks for which electronic transaction workflows are available. As described with some examples, the prompt can be implemented by an LLM service 55, and the LLM service 55 can be part of the network system 10. Alternatively, the LLM service 55 can external to the network system (e.g., operated by a third-party).

At block 304, the network system 10 matches the first natural language message to a portion of the electronic transaction workflow based on a first textual output generated by the machine learning model in response to the first natural language message and the first contextual prompt. Continuing with the above example, the network system 10 may determine, based on a response to the prompt from the LLM that corresponds to the first textual output, that the chat input indicates an intent to perform a task associated with the electronic transaction workflow. The network system 10 may also use the response to determine a part of the electronic transaction workflow to which the chat input pertains.

At block 306, the network system 10 generates, using a tree-based model for the electronic transaction workflow, a first natural language response that includes a query for one or more data elements associated with the electronic transaction workflow. The tree-based model may include a hierarchy of questions and/or decisions that are used to obtain the data element(s) needed to perform the task. Network system 10 may provide the tree-based model to the LLM along with an instruction to generate one or more responses to the chat input that can be used to request some or all of the data elements specified in the tree-based model. Network system 10 may also, or instead, retrieve the natural language response from a portion of the tree-based model to which the chat input was matched.

At block 308, network system 10 causes the first natural language response to be transmitted to the computing device. For example, network system 10 may cause the first natural language response to outputted in a chat user interface within the computing device.

At block 310, network system 10 inputs additional natural language messages received from the computing device and one or more additional contextual prompts associated with the electronic transaction workflow into the machine learning model. For example, network system 10 may receive each additional natural language message as an additional chat input from the computing device. Network system 10 may input a prompt that includes the additional chat input and one or more instructions corresponding to the additional contextual prompt(s) into the LLM. The instruction(s) may ask the LLM to verify that each chat input from the user continues to be related to the task. The instruction(s) can also, or instead, ask the LLM for suggested chat responses that can be used to redirect the chat back to the task after a given chat input is determined to be unrelated to the task. The instruction(s) can also, or instead, ask the LLM to extract specific pieces of information related to the task from the chat input. The instruction(s) can also, or instead, request that the LLM generate additional chat responses 12 that can be used to obtain other information related to the task from the user. The instruction(s) can also, or instead, ask the LLM to determine if all information needed to perform the task has been obtained.

At block 312, network system 10 generates one or more mappings between one or more portions of the additional natural language message(s) and the data element(s) based on additional textual outputs generated by the machine learning model in response to the second natural language message and the additional contextual prompts. For example, network system 10 may extract the mappings from responses to prompts generated by the LLM. Network system 10 may also, or instead, parse the additional chat input to identify portions of the chat input that correspond to the data element(s) and generate mappings between these portions and the data element(s).

At block 314, network system 10 causes the electronic transaction workflow to be performed based on the mapping(s). For example, after the LLM generates a response indicating that the information needed to perform the task is complete, network system 10 may transmit a request that includes the mapping(s) to one or more plug-ins and/or services that are capable of performing the task. The plug-ins and/or services may use the mapping(s) to carry out the task. In another example, after the LLM generates a response indicating that the information needed to perform the task is complete, network system 10 may transmit a message that includes the information to a human agent to allow the human agent to perform the task on behalf of the user.

FIG. 4 illustrates a method 400 for using a natural language exchange to perform a task for a user, according to one or more embodiments. At block 402, network system 10 processes a natural language exchange of a user with another entity to determine or more parameters of a requisite set of multiple parameters for performing a task.

As illustrated with examples described with FIG. 1, the natural language exchange correspond to a chat between a user and the chatbot 102. In variations, the natural language exchange can be for example, a text exchange or communication, such as provided through a messaging application or service. In some variations, the natural language exchange can be conducted through voice, and network system 10 can convert the voice exchange to text content for processing. As another alternative, network system 10 can acquire a text stream from another programmatic component that converts a voice communication of a user into the text.

In variations, natural language exchange can be conducted between automated entities and humans, between multiple humans and a programmatic entity, or between humans. For example, network system 10 can include a messaging service, messaging application, plug-in or other programmatic component that receives, scans or otherwise acquires user-generated content in real-time, such as upon a user sending text-based content to another user, or between two users speaking to one another through an application or device. In such examples, examples can be implemented to automate performance of tasks which arise in the course of a conversation, for one or both users.

Still further, as an addition or alternative, the programmatic component of network system 10 can scan and acquire text from a stored or archived set of user-generated content (e.g., chat history, message archive, transcribed conversation, etc.). In such examples, the archival can be scanned for determination of tasks, where the determination of tasks (as well as requisite information) is done asynchronously with the actual exchange.

Network system 10 can initiate or perform, for example, one or multiple types of analysis on a text stream detected through the exchange to detect a user's intent to have network system 10 perform a particular type of task. For example, network system 10 can analyze an exchange to identify (i) whether the exchange is a new exchange or pertains to a prior exchange, (ii) whether the exchange pertains to a type of task, and/or (iii) whether requisite information for performing the task can be obtained from the exchange. In some examples, the workflow engine 100 is initiated to utilize a natural language service to determine user intent and requisite information. In variations, the workflow engine 100 can implement alternative modes, including an alternative mode where determinations are made based on, for example, keyword analysis, context, historical information, and/or other information, to determine what type of task the user wishes to have performed. The task type can correspond to a reservation, a booking, a purchase or other task. In some examples, the task type can be determined through natural language processing, at the same time or concurrently with identification of parameters for performing the task.

Depending on implementation, the type of task can include, for example, a travel booking (e.g., flight, cruise, shuttle, train, etc.), a reservation (e.g., restaurant, event center), an acquisition (e.g., purchasing ticket to cinema, sporting event, concert, theater, etc.) or other task. For each type of task, network system 10 can identify a requisite set of multiple parameters for completing the requisite task. The requisite set includes all information that is required to satisfactorily perform the task. In some examples, the requisite information can include all user-specified selections or other input for achieving a predefined outcome, where the predefined outcome is specific to the task or resource. For example, for an online booking or reservation, the requisite information is information necessary to search and identify a booking that meets user criteria.

In some examples, the requisite information can be predefined to consist of information necessary for achieving a particular or predetermined result or output for the user, where the particular or predetermined result or output is specific to the type of task, service where task is performed or other context. In the case of an online booking, for example, the result or output can correspond to the generation of a purchasing page for a single booking that satisfies criteria of the user intent, where, for example, the user needs to confirm the booking is correct and/or enter payment information. The particular outcome or result can vary based on factors such as a source. For example, for a particular booking engine, the final steps reserved for the user to perform can include confirmation by the user to terms specified of the carrier or booking engine, followed by confirmation/payment pages etc. To further the example, the performance of a task can also (or alternatively) include generation of a calendar entry for the user, where the start and stop times/days of the task are prefilled, such that the user needs only mark “save” or provide confirmation input. In such case, the requisite information can include information that enables the user to save or confirm the calendar entry, with sufficient information to indicate the event identified from the user's natural language exchange. Still further, the performance of a task can include composing a message or communication on behalf of the user, where the requisite information identifies the recipient, as well as information that is to be specified in the body of the message.

Still further, with respect to examples as described, the workflow engine 100 can perform tasks that automate the final desired outcome or result. For example, in the case of a booking engine, the workflow engine 100 can use requisite information determined from a natural language to book a flight, make a reservation, create and save a calendar entry and/or compose a message. In such examples, the workflow engine 100 can use, for example, processes of resource manager 130 to access user account information (e.g., mileage plan with booking engine, online calendar or messaging service, etc.), user preferences (e.g., type of seating), user payment information and other information for automating completion of a task through the final steps.

Network system 10 can associate each task type with a task-specific set of multiple requisite parameters. Thus, in some examples, the requisite set of parameters can be identified with identification of the task type. In variations, the type of task is known a priori, such as at the time the workflow engine 100 is triggered or initiated by a chat input 11. By way of illustration, examples as described can be implemented as part of an airline reservation service or booking engine, such that the workflow engine 100 only performs online bookings and reservations for air and related travel.

In some variations, network system 10 uses a natural language processing engine or service to perform the natural language processing. For example, network system 10 can transmit (via the LLM interface 115) a communication that includes chat history and decision logic (e.g., decision tree 129), to a third-party LLM service 55. In variations, the LLM service 55 can be integrated or provided with the workflow engine 100 and/or network system 10. Network system 10 can initiate or perform natural language processing to determine parameters specified in the text exchange for performance of a task. The natural language processing can include utilizing one or more LLMs to evaluate what information was provided in the natural language exchange, where the evaluation identifies values corresponding to parameters for performing the task.

In examples, where task type is a flight reservation, the requisite set of parameters can include departure city (or airport), destination city (or airport), and date (or date range) for departure and return (if applicable). The requisite set of parameters can also include one or more of (i) the number of travelers, (ii) whether the flight is to be direct, one stop or less, or whether it can have multiple stops, (iii) the permissible trip duration time with stops, (iv) the particular airline, and/or (v) the price range for the reservation, (vi) the class of travel (e.g., first class, business class, coach, etc.) for individual traveler, (vii) whether the user intends to use miles/rewards, and/or (vii) the payment method (e.g., particular credit card the user wishes to use). The requisite set of parameters may include additional flight parameters, such as whether the flight is one way or round trip. The chatbot 102 can be used to determine the requisite information. As the information is determined (e.g., responsive to chat input from the user), the chat history is communicated to the LLM service 55 for analysis and determination of user intent (e.g., does the user interaction pertain to a particular task, such as air travel reservation), and identification of requisite information for performing the task. Further, in examples, the chatbot 102 can communicate logic (e.g., decision tree 129) to establish a hierarchical structure or sequence to the determination of requisite information (e.g., initially determine whether air travel is one-way or round trip, etc.).

In the example where the task type is a restaurant reservation, the requisite set of parameters can include a restaurant identifier, a date (or date range), time (or time range, like “dinner” or 6 pm-8 pm), and number of persons in the party. The restaurant identifier can include, for example, a name (or partial name) of a desired restaurant, a nickname for the restaurant, a location, a cuisine type (e.g., “Chinese food”, “sushi”, “steak”, etc.), a non-food related feature of the restaurant (e.g., “good happy hour”, “someplace where I can get a martini”, “ADAA compliant”, etc.). The requisite set of parameters can further include, for example, dietary restrictions (e.g., allergies, vegetarian, etc.) or special considerations or requests (e.g., birthday party, request for particular table or room, etc.). Thus, the requisite set of information can vary based on the type and specifics of the task (e.g., for one-way travel, only departure date is required, while for round-trip, return trip is required).

At block 404, the network system 10 makes a determination as to whether any parameters of the requisite set are omitted from a given natural language exchange. The determination can be based on the natural language processing. In examples, network system 10 can perform the natural language processing to determine an identified subset of requisite parameters. The identified subset can then be compared to the requisite set to identify an omitted set of requisite parameters. Alternatively, the LLM service 55 can be prompted to determine whether all of the requisite information has been provided through the chat history. For example, the decision tree 129 can include an instruction or request for the determination as to whether all requisite information has been provided for performing a task of the user's intent.

In other variations, the determination of whether all of the requisite information has been provided, as well as what requisite information is needed (or still required) can be determined through implementation of models (e.g., template tasks). The models or templates for tasks can identify, for example, identify requisite parametric information that is required for performing a task, as well as information for meeting a user preference for the task (e.g., whether the user wishes to upgrade class of travel or use miles, etc.).

If the determination in block 404 is that one or more parameters of the requisite set are omitted (such that the omitted set of parameters is not a no set), then at block 406, network system 10 generates or otherwise provides a natural language prompt to the user, where the prompt guides or otherwise request the user to supplement natural language exchange with information correlating to omitted parameters. The natural language prompt can be textual, communicated to the user through, for example, a chat or messaging interface, or alternatively, through an audio transcription.

At block 408, a user response to the prompt supplements the natural language exchange (e.g., appends the chat history 121 with additional chat input 11 and response 12). In response, the method 400 performs steps illustrated by block 402, 404, 406 using the supplemented natural language exchange (e.g., appended chat history 121). In some examples, the chatbot 102 supplements the chat history 121 with the additional exchange (e.g., response/prompt 12 for information, chat input 11 from user, etc.) and submits the appended chat history 121 to the natural language service 55 with the decision tree 129. In such examples, the natural language service 55 performs the analysis as guided by the decision tree 129 without incorporating any history. Thus, for example, the natural language service 55 may perform without knowledge or state of its own prior determinations for the same chat history 121.

If the determination at block 404 is that no parameters of the requisite set or omitted, then at block 412, network system 10 can perform the task using the requisite set of parameters, as identified from the text exchange. In this way, network system 10 is able to perform a recursive process that determines what information is missing in order for network system 10 to successfully complete the task as described with examples.

As described, requisite information can be recursively obtained through chat sessions and other natural language exchanges, for purpose of performing tasks on behalf of a user. Through implementation of examples such as described, the natural language exchanges can be optimized, so as to require fewer exchanges than would typically be required for the user to perform a task, without adding resources and burden associated with guiding a user to provide structured user input.

### Hardware Diagram

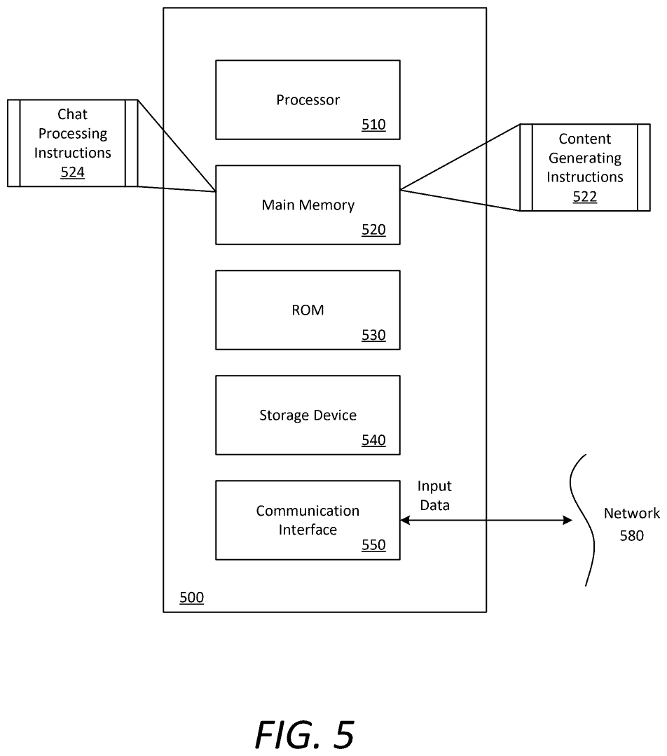

FIG. 5 is a block diagram that illustrates a computer system upon which examples described herein may be implemented. For example, in the context of FIG. 1, the network system 10 may be implemented using a computer system 500 such as described by FIG. 5, or a combination of computer systems 500.

In one implementation, a computer system 500 includes processing resources 510, a main memory 520, a read-only memory (ROM) 530, a storage device 540, and a communication interface 550. The computer system 500 includes at least one processor 510 for processing information and instructions stored in the main memory 520, random access memory (RAM) or other dynamic storage device 540 that stores information and instructions to be executed by the processor 510. The main memory 520 also may be used for storing temporary variables or other intermediate information during execution of instructions to be executed by the processor 510. The computer system 500 may also include the ROM 530 or other static storage device 540 for storing static information and instructions for execution by the processor 510. The storage device 540, such as a magnetic disk, optical disk, external hard driver, etc. is provided for storing information and instructions, such as instructions to implement the P2P transaction service described throughout the present disclosure.

The communication interface 550 can enable the computer system 500 to communicate with one or more networks 580 (e.g., cellular network) through use of the network link (wireless or wired). Using the network link, the computer system 500 can communicate with one or more computing devices and/or one or more servers.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software. In examples provided, the instructions execute to initiate and implement the chat engine described with examples of FIGS. 1-4, on a server or network computer system.

In various implementations described herein, the executable instructions can comprise chat processing instructions 524 and content generating instructions 522. The processor 510 executes the content generating instructions 522 to generate display data that causes a customized, interactive user interface for each user to access and interact with the messaging and transaction services described herein. The processor 510 further executes the chat processing instructions 524 to process and/or conduct a chat.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A non-transitory computer-readable medium storing instructions, that when executed by one or more processors of a computer system, cause the computer system to perform operations that comprise:
(a) processing a natural language exchange of a user to determine one or more parameters of a requisite set of multiple parameters for performing a task;
(b) making a determination as to whether any parameters of the requisite set are omitted from the natural language exchange;
(c) if the determination is that one or more parameters of the requisite set are omitted, (i) generating a set of natural language prompts to prompt the user to supplement the natural language exchange; and (ii) repeating (a) through (c) using the supplemented natural language exchange; and
(d) if the determination is that no parameters of the requisite set are omitted, performing the task using the requisite set of parameters.

2. The non-transitory computer-readable medium of claim 1, wherein (a) includes using a natural language processing engine to process the natural language exchange.

3. The non-transitory computer-readable medium of claim 2, wherein using the natural language processing engine includes communicating with the natural language processing engine using a network interface.

4. The non-transitory computer-readable medium of claim 1, wherein (a) includes determining a type of the task, and determining the requisite set is based at least in part on the type of the task.

5. The non-transitory computer-readable medium of claim 4, wherein the operations further comprise:
using a tree-based model to process the natural language exchange and/or make the determination, wherein the tree-based model is based at least in part on the type of task.

6. The non-transitory computer-readable medium of claim 4, wherein the type of task includes (i) booking a reservation for the user, or (ii) ordering an item at a venue.

7. The non-transitory computer-readable medium of claim 1, wherein the operations further comprise:
determining a set of preferences or tendencies of the user with respect to the task; and
determining one or more parameters for performing the task based on the set of preferences.

8. The non-transitory computer-readable medium of claim 7, wherein determining the set of preferences or tendencies of the user includes determining the one or more parameters from a prior instance when the task was performed for the user.

9. The non-transitory computer-readable medium of claim 1, wherein the natural language exchange of the user is between the user and an artificial chat interface.

10. The non-transitory computer-readable medium of claim 9, wherein the set of natural language prompts is generated as output through the artificial chat interface.

11. A computing system, comprising:
one or more processors; and
one or more memory resources to store a set of instructions that, when executed by the one or more processors, cause the computing system to perform operations comprising:
inputting a first natural language message received from a computing device and a first contextual prompt associated with a first electronic transaction workflow into a machine learning model;
matching the first natural language message to a first portion of the first electronic transaction workflow based on a first textual output generated by the machine learning model in response to the first natural language message and the first contextual prompt;
generating, using a tree-based model for the first electronic transaction workflow, a first natural language response to the first natural language message, wherein the first natural language response comprises a query for one or more data elements associated with the first electronic transaction workflow;
causing the first natural language response to be transmitted to the computing device;
after the first natural language response is transmitted to the computing device, inputting a second natural language message received from the computing device and a second contextual prompt associated with the first electronic transaction workflow into the machine learning model;
generating one or more mappings between one or more portions of the second natural language message and the one or more data elements based on a second textual output generated by the machine learning model in response to the second natural language message and the second contextual prompt; and
causing the first electronic transaction workflow to be performed based on the one or more mappings.

12. The computing system of claim 11, wherein the instructions further cause the computing system to perform operations comprising:
inputting a third natural language message received from the computing device and a third contextual prompt into the machine learning model;
matching the third natural language message to a portion of a second electronic transaction workflow based on a third textual output generated by the machine learning model in response to the third natural language message and the third contextual prompt; and
causing the second electronic transaction workflow to be performed based on the third natural language message and the third textual output.

13. The computing system of claim 11, wherein the instructions further cause the computing system to perform operations comprising:
generating a second natural language response to the second natural language message based on the second textual output; and
causing the second natural language response to be transmitted to the computing device.

14. The computing system of claim 11, wherein the instructions further cause the computing system to perform operations comprising:
causing the first electronic transaction workflow to be performed based on one or more additional data elements corresponding to one or more portions of the first natural language message.

15. The computing system of claim 11, wherein generating the first natural language response comprises:
determining a portion of the tree-based model corresponding to the first portion of the first electronic transaction workflow;
inputting the first portion of the tree-based model into the machine learning model; and
receiving the first natural language response as a response from the machine learning model to the inputted first portion of the tree-based model.

16. The computing system of claim 11, wherein the first electronic transaction workflow comprises a travel booking.

17. The computing system of claim 16, wherein the one or more data elements comprise at least one of a booking type, a number of stops, a travel mode, a departure location, an arrival location, a departure date, or a return date.

18. The computing system of claim 16, wherein causing the first electronic transaction workflow to be performed comprises generating a recommended itinerary for the travel booking based on the one or more data elements.

19. The computing system of claim 16, wherein causing the first electronic transaction workflow to be performed comprises transmitting the one or more mappings to an additional computing device associated with a human agent.

20. The computing system of claim 11, wherein the second textual output is further generated by the machine learning model based on the first natural language message and the first contextual prompt.

21. A computer-implemented method comprising:
inputting a first natural language message received from a computing device and a first contextual prompt associated with a first electronic transaction workflow into a machine learning model;
matching the first natural language message to a first portion of the first electronic transaction workflow based on a first textual output generated by the machine learning model in response to the first natural language message and the first contextual prompt;
generating, using a tree-based model for the first electronic transaction workflow, a first natural language response to the first natural language message, wherein the first natural language response comprises a query for one or more data elements associated with the first electronic transaction workflow;
causing the first natural language response to be transmitted to the computing device;
after the first natural language response is transmitted to the computing device, inputting a second natural language message received from the computing device and a second contextual prompt associated with the first electronic transaction workflow into the machine learning model;
generating one or more mappings between one or more portions of the second natural language message and the one or more data elements based on a second textual output generated by the machine learning model in response to the second natural language message and the second contextual prompt; and
causing the first electronic transaction workflow to be performed based on the one or more mappings.
